(19) United States
(12) Patent Application Publication
(10) Pub. No.: US 2003/0026435 A1
(43) Pub. Date: Feb. 6, 2003

(54) Focussing electroacoustic transducer and method for testing its output power

(75) Inventor: Edgar Bauer, Kraichtal (DE)

Correspondence Address: Thomas C. Pontani, Esq., Cohen, Pontani, Lieberman & Pavane, Suite 1210, 551 Fifth Avenue, New York, NY, 10176, US

(73) Assignee: Richard Wolf GmbH

(21) Appl. No.: 10/213,125

(22) Filed: Aug. 6, 2002

(30) Foreign Application Priority Data
Aug. 6, 2001 (DE) 101 38 434.3

(51) Int. Cl. H04R 29/00

(52) U.S. Cl. 381/56

(57) ABSTRACT

With a focusing electroacoustic transducer with a carrier which on its front side is equipped with a first group and on its rear side with a second group of ceramic piezolelements, a testing of the transducer power in a transducer test operating mode is carried out in that one of the element groups on the front or rear side is impinged with a high voltage impulse corresponding to the high voltage produced on normal operation of the transducer, and thereupon a secondary voltage impulse serving as a measurement voltage which at the same time is produced by a mechanical loading of the piezoelements of the other group transmitted by the carrier, as a measure of the present transducer power of the activated element group is compared to pregiven, previously determined and stored reference values of the transducer power of the activated element group.

### BACKGROUND OF THE INVENTION

The invention proceeds from a focusing electroacoustic transducer with a carrier which on its front side is equipped with a first group and on its rear side with a second group of ceramic peizoelements, wherein in normal operation the first element group may be activated time delayed with respect to the second element group with in each case a high voltage impulse and may be set into operation for emitting sound.

With shockwave therapy the output power of the electroacoustic transducer must be checked within a certain time interval. With such extracorporeal therapy apparatus the power of the electroacoustic transducer is usually checked by a hydrophone measurement in a water bath. With a measuring microphone arranged in the water opposite the transducer and set up to detect the produced shockwave, the peak pressure in the focus of the transducer is measured and the measured value is compared to earlier measurements. A hydrophone measurement is relatively complicated and has the disadvantage that it may only be carried out by skilled personnel.

In the patent document DE 41 02 551 C2 there is described a measuring arrangement which brings a reflection body into the sound field of the electroacoustic transducer in order via the reflected signal which in turn generates a voltage in the transducer, to determine the sound output. With this measuring method there exists the disadvantage that the reflection body must be exactly adjusted in the sound field. A further disadvantage is the relatively small voltage which is produced by the reflected sound in the electroacoustic transducer to be measured, since the voltage must be measured at the leads of this, which shortly before were impinged with a high voltage of several kV and at the point in time of measurement is still loaded with spurious signals.

According to a method described in the Utility model DE 298 23 797 U a measuring transducer which on the side receiving sound has a specially curved surface is applied into the sound field produced by the electroacoustic transducer to be measured such that the symmetry axes of the sound producer and of the measuring transducer lie on a line of symmetry running through their two focuses. By way of this one may derive measurement signals from the measuring transducer which relate to the sound output to be measured and which as useful signals are clearly lifted from spurious signals. With this measuring arrangement too the measuring transducer must be adapted to the geometry of the electroacoustic transducer and simultaneously be exactly fitted into its field of sound.

It is the object of the invention to specify a focusing electroacoustic transducer and a method for testing its output power, wherein the previously outlined advantages of the state of the art are to be avoided and an exact checking of the output power of the transducer is to be made possible without a measuring transducer being brought into its field of sound.

This object is achieved by the features specified in the independent claims 1 and 4.

By way of the fact that the electroacoustic transducer in a transducer test operating mode is arranged to activate one of the element groups with a primary high voltage impulse corresponding to the high voltage impulse produced on normal operation and thereupon to receive a voltage impulse as a measurement signal produced by the piezoelements of the other element group due to a mechanical loading transmitted via the carrier, and to compare this measurement signal to pregiven, previously determined and stored reference values, a checking of the transducer power may be effected in which only one element group on the front and rear side is activated with a high voltage impulse and the secondary voltage impulse produced at the opposite element group is measured and evaluated.

With the transducer according to the invention the determined data are stored in a memory of a micro-controller and thus at any time may be compared to more recent measurements. With this one may determine whether the transducer power weakens usually caused by damage to the transducer.

For this the transducer according to the invention may usefully comprise a microcontroller, a mains part which may be activated and adjusted and is set up for producing the high voltage, a switch means for an impulse-like switching of the high voltage produced by the mains part to the respective element group, a trigger means which may be activated by the microcontroller and which is set up for producing a trigger signal which is supplied to the switch means for switching, and an A/D converter which on the input side is connected to at least one of the leads and on the output side to the microcontroller, wherein the measurement voltage produced in the transducer test operation mode by one element group is digitalised by the A/D converter and transmitted to the microcomputer which is set up to compare the digitalised and stored measurement voltage with the reference values which have been previously stored in it and to display the comparison result on a display.

Usefully the switch means and the A/D converter may be coupled to the leads of the first and second element group or may be switched on by the trigger means, such that the activation with the primary high voltage impulse and the derivation of the secondary measurement voltage in each case may be changed between the first and the second element group.

A method according to the invention for solving the above object and for testing the output power of a focusing electroacoustic transducer which is equipped on the front side with a first group and on the rear side with a second group of ceramic piezolelements, wherein in normal operation the first element group may be activated time-delayed with respect to the second element group with in each case a high voltage impulse and may be set into operation for emitting sound, is characterised by the following steps:

A one of the element groups is activated with a primary high voltage impulse which corresponds to a high voltage impulse produced in the normal operation of the electroacoustic transducer;

B a secondary voltage impulse which is produced in the piezoelements of the other element group by way of mechanical loading transmitted via the carrier after the primary high voltage impulse produced in step A is derived as a measurement signal;

C the secondary voltage impulse produced in step B and derived as a measurement signal is compared to at least one pregiven

and previously evaluated reference value of the transducer power of the activated element group.

Usefully three reference values evaluated with preceding measurements of the intact electroacoustic transducer are stored for the transducer power, and specifically normal values which respectively correspond to the maximal compression, the maximal deflection and the compression directly following the maximum compression, of the piezolements of that element group from which the secondary measurement voltage is derived.

By way of the electroacoustic transducer according to the invention and the method according to the invention for testing the output power of this, one may detect the following changes or damage of the electroacoustic transducer:

reduction in power of the piezoceramic, caused by mechanical damage, ageing, etc.;

damaged adhesive locations, in particular of the piezoceramic on the transducer calotte serving as a carrier;

piezoelements detached from the transducer calotte, and

changes in the cast compound, which may effect a weakening of the adhesing to the piezoceramic, etc.

### BRIEF DESCRIPTION OF THE DRAWINGS

Hereinafter there are described embodiment examples of the transducer according to the invention and a test method in reference with the drawings. Individually the drawing show:

FIG. 1: schematically, a transducer according to the invention with transducer activation and test circuit drawn in the manner of a block diagram,

FIG. 2: a flow diagram for illustrating individual steps of the test method according to the invention and

FIGS. 3a and 3b: graphically, the temporal course of a secondary voltage impulse which may be detected with the test method according to the invention, with an intact and with a damaged electroacoustic transducer.

### DETAILED DESCRIPTION OF THE INVENTION

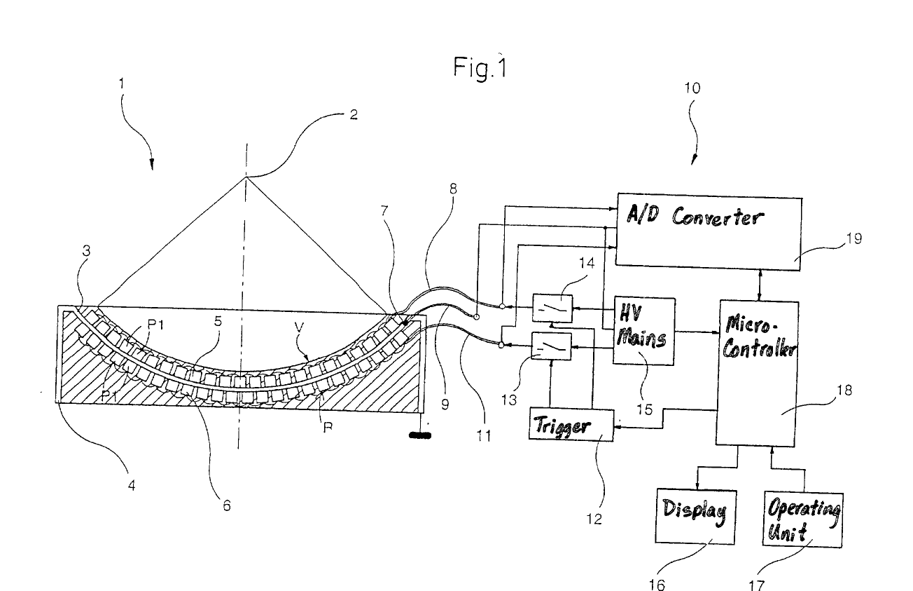

The focusing electroacoustic transducer 1 shown in the left half of FIG. 1, whose basic construction is described in DE 197 33 233 C1, comprises a conducting calotte-shaped carrier 3, which is designed as one piece with a tube section 4 with which the transducer is fastened within the apparatus arrangement, e.g. a therapy apparatus. The caloffe-shaped carrier 3 comprises on its front side V facing the transducer focus 2 a first element group 5 of ceramic piezoelements P1 and on a rear side R turned away from this, a second element group 6 of ceramic piezolelements P2. The ceramic elements P1, P2 with one of their end faces are electrically connected to the front side and rear side of the carrier 3 respectively and are fastened to this. The free end faces of the ceramic elements P1, P2 are connected to one another by thin wires. The intermediate spaces of the front-side and rear-side ceramic elements P1, P2 are filled with an obliquely hatched high-voltage insulation material which encloses the elements P1, P2 also at their free end faces.

Connection cables 8, 9, 11 from the side of the transducer drawn on the right lead to a circuit arrangement 10 which is set up for carrying out a normal operating mode and the subsequently explained transducer test operating mode. The supply lead 8 is connected to the end faces, connected to one another, of the first element group 5 lying on the front side V of the carrier 3, and the supply lead 11 to the free end faces, electrically connected to one another, of the second element group 6 lying on the rear side R of the carrier 3, whilst the supply lead 9 is connected to the electrically conducting carrier 3.

The circuit arrangement 10 comprises the following parts: a microcontroller MCU 18, a high voltage mains part 15 for producing a high voltage, which may be activated and adjusted by the microcontroller 18, a high voltage switch means with two switches 13, 14 for the impulse-like switching of the high voltage produced by the high voltage mains part 15 to the first and second element group 5, 6 via the leads 8 and 11 respectively, a trigger means 12 which may be activated by the microcontroller 18 and which produces a trigger signal which is lead to the switch means for switching the switch means 13, 14, and an A/D converter 19 connected to the leads 8 and 11 on the input side and to the microcontroller 18 on the output side. Furthermore FIG. 1 shows that the circuit arrangement 10 comprises a display unit and an operating unit 17 connected to the microcontroller 18. A temperature sensor 7 may be attached at any location of the carrier calotte 3 of the electroacoustic transducer 1, whose function will be explained further below.

In normal operation the transducer 1 is activated as follows. At the operating unit 17 the desired shock wave intensity is set, whereupon the microcontroller 18 at the high voltage mains part 15 sets the corresponding high voltage. If now there is effected a release of a shock wave at the operating unit 17, then the microcontroller 18 releases the trigger means 12, whose trigger signal directly afterwards triggers the high voltage switch 13 and after a given delay time the high voltage switch 14, for producing a high voltage impulse. The high voltage impulse via the high voltage switches 13 and 14 goes from the mains part 15 to the high voltage connections 8 and 11 which are connected to the respective ceramic piezoelements P1 and P2 on the front and rear side V, R.

According to the invention there is now effected the checking or a test of the transducer power in that only one element group 5 or 6 on the front or rear side V, R is activated with a high voltage impulse which corresponds to the high voltage impulse produced in normal operation. Thereupon at the opposite side, i.e. at the element group which is not activated, the secondary voltage impulse which is produced by transmission of the mechanical shock by the activated element group via the carrier 3 to the element group which is not activated, is measured.

For carrying out this transducer test one uses the microcontroller present in the circuit arrangement 10 and the A/D converter 19 which is connected to the microcontroller and which is connected to at least one high voltage connection lead of the transducer or, as shown in FIG. 1, is connected to both high voltage connection leads 8 and 11 of the transducer 1.

Before carrying out the practical transducer test, with an intact or new transducer 1, e.g. on the part of the manufacturer, the corresponding voltage values are measured with the same method and stored as reference values in the memory of the microcontroller, and by way of this at any time may be compared to the presently evaluated voltage readings. With this comparison one may ascertain whether the transducer power weakens on account of damage to the transducer.

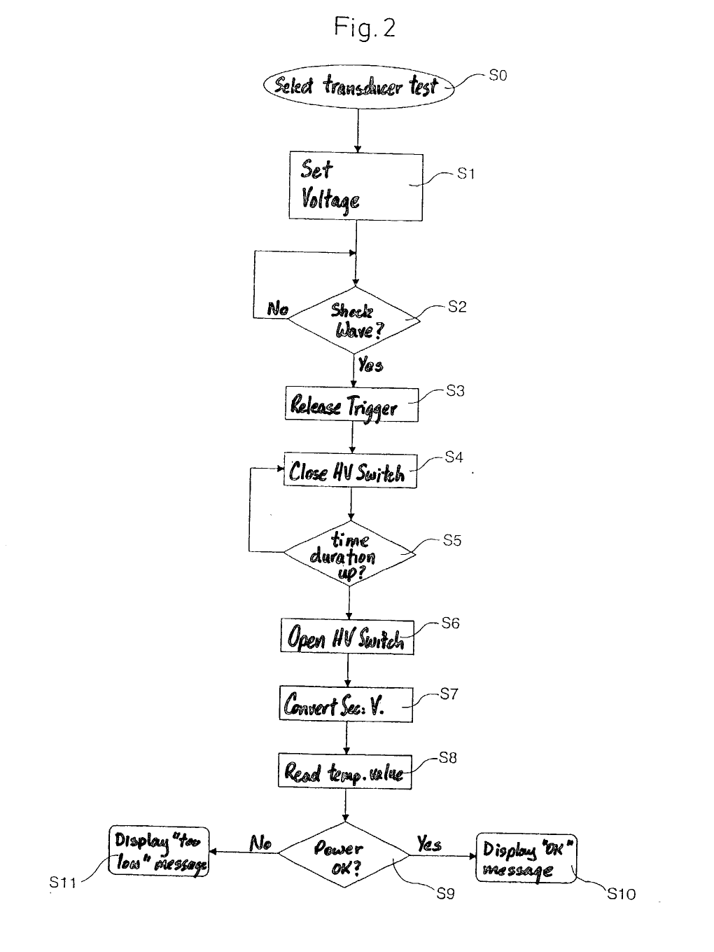

Hereinafter the individual steps of a transducer test carried out with the method according to the invention on such an electroacoustic transducer is explained in more detail by way of a flow diagram represented in FIG. 2.

In the operating unit 17 of the therapy apparatus in the menu the program “transducer test” is selected and by way of this an automatic test cycle is started (step S0).

The microcontroller 18 sets the voltage at the high voltage mains part 15, with which the transducer 1 is to be activated (step S1).

The microcontroller 18 waits for a release of a shock wave which is triggered via a hand butfon on the operating unit (step S2).

After the release of a shock wave has been effected, in the trigger means 12 the microcontroller 18 releases the trigger for the high voltage step (step S3), by which means the high voltage switch (e.g. switch 13) is actuated, i.e. closed (step S4).

This high voltage switch remains switched on for a certain time duration (e.g. 10 is) (step S5).

Subsequently the high voltage switch is opened again (step S6).

The transducer 1 then for a short time was impinged with the high voltage impulse (primary voltage impulse Up) on the rear side R. The mechanical shock impulse produced by the element groups 6 on the rear side of the carrier 3 is transmitted via the carrier 3 and the casting mass onto the element group 5 located on the front side, whereupon at the high voltage connection lead 8 which is connected to the element group 5 located on the front side V one may tap off a voltage impulse (secondary voltage impulse Us).

This secondary voltage impulse is converted by the A/D converter 19 into a digital signal and read into the microcontroller 18 (step S7). Then an optional step S8 is effected with which the microcontroller 18 reads in the temperature value of the transducer 1 by way of the temperature sensor 7.

In step S9 the microcontroller 18 compares the digitalised values of the secondary voltage impulse Us read in from the A/D converter 19 to the corresponding values which have been previously stored in the memory as reference values, as had previously been stored by way of a power test measurement of the new transducer. After assessment by the microcontroller 18 these may be indicated on the display 16, e.g. “transducer power OK” (step 10) or “transducer power too low” (step S11).

The circuit arrangement 10 shown in FIG. 1 is also set up in combination with the electroacoustic transducer 1 such that firstly the first element group 5 located on the front side V of the transducer 1 is activated with the primary high voltage impulse Up by closing the switch 14 and the measurement of the secondary voltage impulse Us from the second element group 6 arranged on the rear side R is effected. For this the high voltage connection lead 11 is likewise led to the A/D converter 19. In this manner the transducer measurement may be carried out alternately after one another with respect to time on each transducer side V, R, which further improves the reliability and accuracy of the test results.

The monitoring of the temperature of the electroacoustic transducer 1 with the help of the temperature sensor 7 and the subsequent adaptation of the readings, described in step S8, is merely an optional embodiment example. It would usually be sufficient to evaluate the amplitudes of the secondary voltage impulse being considered at various temperatures and to store the characteristic curves obtained from this in the microcontroller 18, by which means a reading adaption may be effected for each measurement. It is however possible for the temperature characteristic curve not to be the same for each transducer since it is dependent on the materials used for the transducer 1 and the equipping number of the piezoelements. For this one must carry out tests with two transducers which have the upper and the lower maximum of the equipping density. If with this there is a large difference in the temperature characteristic curves, the characteristic curve associated with the transducer must in each case be stored in the memory. If in order to keep the above expense to a minimum the temperature sensor is only applied for monitoring the temperature, the microcontroller 18 with the temperature of the transducer 1 measured by the temperature sensor may decide whether a test power measurement, i.e. the measurement of the secondary voltage impulse Us may be carried out or not.

FIG. 3a graphically shows a typical voltage course of the secondary voltage impulse Us of an intact or new electroacoustic transducer 1, wherein the secondary voltage impulse Us at the high voltage connection lead 8 of the element group 6 on the front side has been measured. At the point in time t0 the piezolement is located in the off-load position (off-load voltage U_{A}). The first voltage maximum U1 at the point in time t1 indicates the voltage value with a maximal compression of the element as a result of a pressure wave. Subsequently the element at the point in time t2 runs through the initial position U_{A}. At the point in time t3 the element is maximally deflected and has a negative voltage maximum U3. Then at the point in time t4 the element again runs through the initial position U_{A}. At the point in time t5 the element is again contacted, the voltage amplitude U5 however no longer reaches the height of the amplitude U1 at the point in time t1.

FIG. 3b schematically shows the course of the voltage of the secondary voltage impulse Us with a damaged transducer with a pressure loss which is caused by the cast compound. The course of the voltage according to FIG. 3b shows that the amplitude U3′ at the point in time t3 and the amplitude U5′ at the point in time t5 are larger due to fracture formation of the cast compound or by way of the detaching of the cast compound from the piezoelement, the mechanical force of the cast compound onto the piezoelement weakens.

The amplitude U1 at the point in time t1 must however still have its maximal value as in FIG. 3a. If the amplitude U1 reduces, the transducer damage would be led back to a damage of the piezoelements or their contactings.

In order to carry out the test of the transducer power and its integrity, it is preferable if previously several reference values with the new and intact transducer are measured and stored. For this by way of measurements on the intact or new electroacoustic transducer at least the three amplitude values U1, U3 and U5 are stored in the memory, in order then to be able to be compared to corresponding presently measured voltage amplitude values.

1. A focusing electroacoustic transducer with a carrier which on its front side is equipped with a first group and on its rear side with a second group of ceramic peizoelements, wherein in normal operation of the electroacoustic transducer the first element group may be activated time delayed with respect to the second element group with in each case a high voltage impulse and may be set into operation for emitting sound, characterised in that the transducer for a transducer test operation is set up such that one of the element groups may be activated with a primary high voltage impulse corresponding to the high voltage impulse produced on normal operation and thereupon a secondary voltage impulse produced by the piezoelements of the other element group due to a mechanical loading transmitted via the carrier may be produced as a measurement signal and as a measure of the present transducer power compared to pregiven, previously determined and stored reference values which indicate the normal transducer power.

2. A transducer according to claim 1, wherein it further comprises: a microcontroller, a mains part which may be activated and set by the microcontroller and is set up for producing the high voltage, a high voltage switch means for an impulse-like switching of the high voltage impulse produced by the mains part to each element group via in each case a connection lead, a trigger means which may be activated by the microcontroller for producing a trigger signal which is supplied to the switch means for switching, and an A/D converter which on the input side is connected to at least one of the connection leads and on the output side to the microcontroller, wherein the secondary voltage impulse tapped from one element group in the transducer test operating mode is digitalised by the A/D converter and transmitted to the microcomputer which is set up to store the digitalised voltage and to compare this to reference values which have been previously stored in it and to display the comparison result on a display.

3. A transducer according to claim 1 or 2, wherein in the transducer test operation mode after activation of the one element group with the primary high voltage impulse and the derivation of the secondary voltage impulse from the other element group, the activation may be reversed by way of a switch means, so that the element group which previously was not activated is now impinged with the primary high voltage impulse and the secondary voltage impulse is derived from the other element group as a measurement signal.

4. A method for testing the output power of a focusing electroacoustic transducer which is equipped on the front side with a first group and on the rear side with a second group of ceramic piezolelements, wherein in normal operation the first element group may be activated time-delayed with respect to the second element group with in each case a high voltage impulse and may be set into operation for emitting sound, wherein the method has the following steps:
A one of the element groups is activated with a primary high voltage impulse which corresponds to a high voltage impulse produced in the normal operation of the electroacoustic transducer;
B a secondary voltage impulse which is produced in the piezoelements of the other element group by way of mechanical loading transmitted via the carrier after the primary high voltage impulse produced in step A, is derived as a measurement signal.
C the secondary voltage impulse produced in step B and derived as a measurement signal is compared to at least one pregiven and in method steps A and B previously evaluated reference value of the transducer power of the activated element group.

5. A method according claim 4, wherein the secondary voltage impulse derived in step B for producing a measurement signal is subjected to an A/C conversion and converted into a digital measurement signal.

6. A method according to claim 4 or 5, wherein with the previously specified power measurement of the intact electroacoustic transducer three voltage amplitudes of the secondary voltage impulse are stored as reference values, which respectively correspond to the maximum compression, the maximum deflection and the compression directly following the maximum compression, of the piezolements of the other element group.

7. A method according to one of the claims 4 to 6, wherein the element group activated with the primary voltage impulse in step A is changed and wherein the secondary voltage impulse is then derived from the respective other element group.
